(19) United States
(12) Patent Application Publication
(10) Pub. No.: US 2023/0219507 A1
(43) Pub. Date: Jul. 13, 2023

(54) GREY WATER RECLAMATION FOR RECREATIONAL VEHICLES

(71) Applicant: WHIRLPOOL CORPORATION, Benton Harbor, MI (US)

(72) Inventors: Marcus R. FISCHER, Stevensville, MI (US); Richard L. HAMMOND, Mattawan, MI (US)

(21) Appl. No.: 17/574,818

(22) Filed: Jan. 13, 2022

(51) Int. Cl. B60R 15/02; C02F 1/00; C02F 1/52; C02F 9/00

(52) U.S. Cl. CPC B60R 15/02; C02F 1/006; C02F 1/52; C02F 9/005; C02F 2103/002

(57) ABSTRACT

A grey water reclamation system for a recreational vehicle includes an on-board use that generates grey water having a contamination level, a grey water treatment tank fluidly connected to the on-board uses to collect the grey water and treat the grey water therein to form treated grey water, and a coagulant dispenser and a flocculant dispenser each fluidly connected to the grey water treatment tank and configured to supply a predetermined amount of coagulant and flocculant, respectively, to the grey water treatment tank. The system also includes a grey water supply tank fluidly connected to the grey water treatment tank configured to receive the treated grey water therefrom and supply the treated grey water to a particular on-board use. The predetermined amount of coagulant is based on the contamination level or a turbidity of the treated grey water.

### TECHNICAL FIELD

The present application is directed to a reclamation system for grey water that can be implemented in recreational vehicles, campers, and/or mobile homes.

### BACKGROUND

The limited water supply in recreational vehicles, boats, campers, and mobile homes (collectively hereinafter, recreational vehicles) results in a tradeoff between carrying the water, space for additional storage due to additional water tanks, and weight. Most water systems onboard recreational vehicles are configured to store both fresh water and wastewater. The storage of fresh water (and, in turn, wastewater) limits how long the recreational vehicle can travel without accessing a fresh water supply and pumping the wastewater out, and as a result, limits user's on-board activity such as number of showers and toilet flushes, shower and sink length, laundry cycles, food preparation and clean up, and the like.

Conventional recreational vehicle water systems typically focus on using less water or involve designs to store more fresh water and also more wastewater. Moreover, not all the wastewater can be reused, nor can the waste water be reused in all circumstances.

### SUMMARY

According to one or more embodiments, a grey water reclamation system for a recreational vehicle includes an on-board use that generates grey water having a contamination level, a grey water treatment tank fluidly connected to the on-board uses to collect the grey water and treat the grey water therein to form treated grey water, and a coagulant dispenser and a flocculant dispenser each fluidly connected to the grey water treatment tank and configured to supply a predetermined amount of coagulant and flocculant, respectively, to the grey water treatment tank. The system also includes a grey water supply tank fluidly connected to the grey water treatment tank configured to receive the treated grey water therefrom and supply the treated grey water to a particular on-board use. The predetermined amount of coagulant is based on the contamination level or a turbidity of the treated grey water.

According to one or more embodiments, a grey water reclamation system for a recreational vehicle includes an on-board use that generates grey water having a contamination level, and a grey water treatment tank fluidly connected to the on-board uses to collect the grey water and treat the grey water to supply treated grey water to particular on-board uses. The system also includes a coagulant dispenser fluidly connected to the grey water treatment, and a flocculant dispenser fluidly connected to the grey water treatment tank. The system also includes a controller configured to, based on the contamination level or a turbidity of the treated grey water, instruct the coagulant dispenser to supply a predetermined amount of coagulant to the grey water treatment tank, and instruct the flocculant dispenser to supply a predetermined amount of flocculant to the grey water treatment tank.

According to one or more embodiments, a method for reclaiming grey water for a recreational vehicle includes determining a contamination level of grey water from an on-board use system, and adding a coagulant to the grey water based on the contamination level to form coagulated particles in the grey water. The method further includes adding a flocculant to the grey water to aggregate the coagulated particles into flocs; separating the flocs from the grey water to form treated grey water; and providing the treated grey water to a laundry device, a toilet, a shower, a tub, or combinations thereof.

### BRIEF DESCRIPTION OF THE DRAWINGS

FIG. 1 is a process schematic of a conventional recreational vehicle water system;

FIG. 2 is a process schematic of a grey water reclamation system for a recreational vehicle, according to an embodiment; and

FIG. 3 is a process flow diagram for the grey water reclamation system of FIG. 2.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

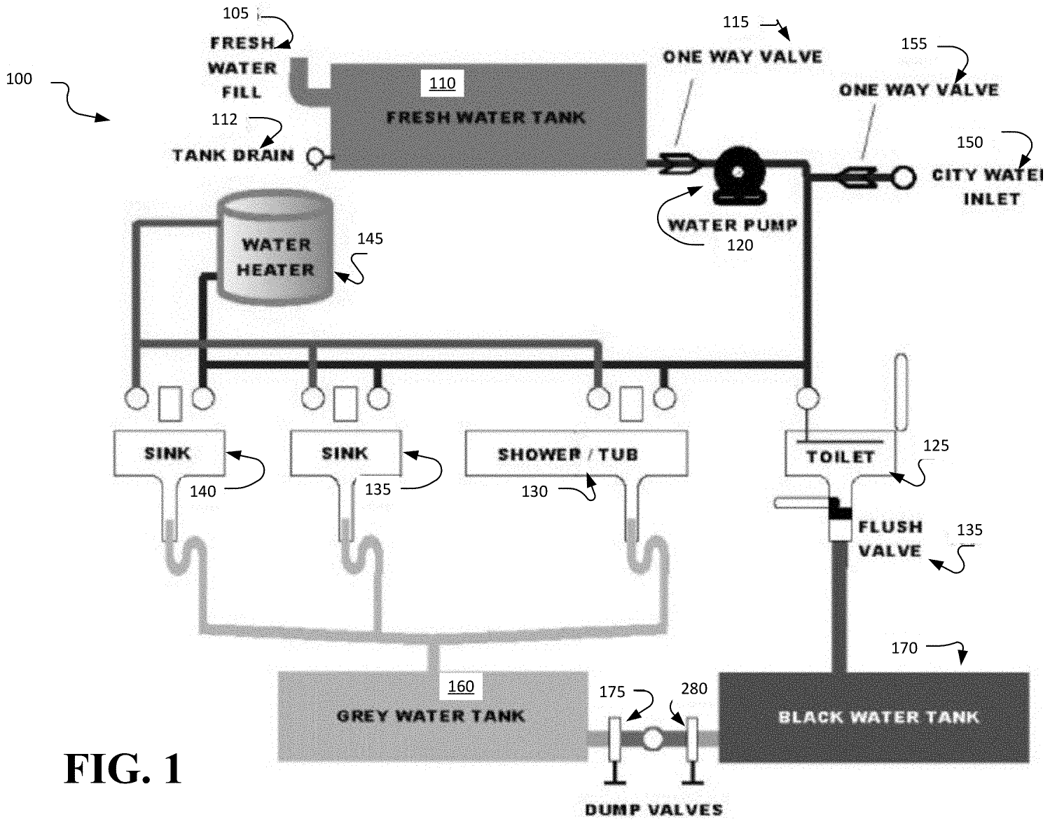

A conventional water system 100 for a recreational vehicle is shown in FIG. 1. Fresh water is supplied via water fill line 105 to a fresh water storage tank 110, which includes a drain 112. To be used, the water is pumped via the water pump 120 upon activation of one way valve 115 to be routed to the where it is to be used, such as the toilet 125, the shower/tub 130, or sinks 135, 140. Some water from the fresh water tank 110 may be supplied to a water heater 145 for supplying heated water to where the water is to be used. In some instances, the conventional water system 100 further includes a city water inlet source 150 which can provide water to where it is to be used via a one way valve 155 when the recreational vehicle has access to city water systems. Generally, wastewater is classified into two categories, grey water and black water, with the fresh water generally being used only once before it is classified into grey water and black water, as shown in FIG. 1. Wastewater from the sinks 135, 140 and the shower/tub 130 is routed to a grey water tank 160, and the wastewater from the toilet 125 is routed to a black water tank 170 via a flush valve 165. The wastewater from the grey water tank 160 and the black water tank 170 can be dumped via activating dump valves 175, 180 respectively, when the recreational vehicle is at an emptying location for the wastewater. As such, the fresh water is used only once, limiting the quantity of fresh water available when no city water is available to supplement, and the limited storage for wastewater on-board limits the potential usage of additional city water when available.

According to one or more embodiments, a water reclamation system for a recreational vehicle is provided. The grey water reclamation system selectively uses grey water on-board the recreational vehicle. Kitchen sink and toilet water (i.e., black water) is not to be reused, and is stored separately. However, grey water (e.g., water from the shower or laundry) can be reused using the grey water reclamation system described herein. The reuse of grey water can either extend the time between water filling and emptying stops and/or reduce the amount of fresh and grey water which has to be stored on board the recreational vehicle. The water reclamation system removes contaminants from grey water from certain uses (e.g., laundry/shower) such that the grey water can be reused in particular uses (e.g., laundry/shower or toilet uses) to reduce the amount of fresh and grey water that needs to be stored in the recreational vehicle and lengthen time between water emptying and filling stops. The contaminants are extracted from the grey water using measured doses of flocculants and coagulants (as based on the surfactant and/or soap contents of the grey water) such that the grey water can be selectively used for various functions after contaminants are extracted (e.g., via a sieve or mesh). The system detects the surfactant and/or soap quantity within the grey water storage tank, and adds the coagulant and flocculant as based on the surfactant and/or soap quantity.

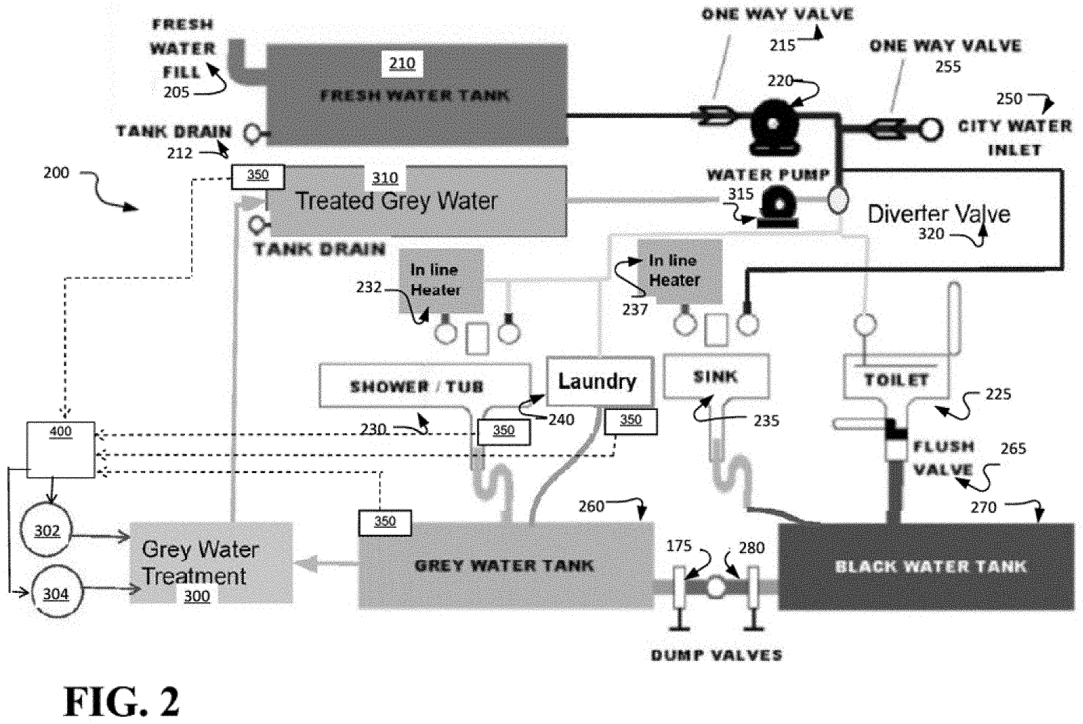

According to one or more embodiments, and with reference to FIG. 2, a grey water reclamation system 200 is provided. The grey water reclamation system 200 includes a fresh water storage tank 210 for receiving, storing, and supplying fresh water to on-board use systems (or, interchangeably, on-board uses) on the recreational vehicle. The on-board uses include, but are not limited to, sink(s) 235, shower/tub(s) 230, toilet(s) 225, and laundry 240. Although certain on-board uses are described herein for producing wastewater, other on-board uses are also contemplated, and discussion of certain on-board uses is not intended to be limiting. The on-board uses may expel wastewater to either the grey water storage tank 260 or the black water storage tank 270, depending on the type of on-board use. For example, the wastewater from the toilet(s) 225 and sink(s) 235 is routed to the black water storage tank 270 via a flush valve 265, and wastewater from the laundry appliance 240, and the shower/tub(s) 230, is supplied to the grey water storage tank 260. The grey water reclamation system 200 also includes a grey water treatment tank 300 (in fluid connection with the on-board uses that generate grey water) for treating wastewater from the grey water storage tank 260 (hereinafter, the wastewater from the laundry 240 and the shower/tub(s) 230 may be collectively and interchangeably referred to as the grey water). The grey water includes surfactants mixed in the water, that are removable at the grey water treatment tank 300. Although the grey water storage tank 260 and the grey water treatment tank 300 are shown as separate tanks in FIG. 2, in certain embodiments, the treatment of the grey water (i.e., addition of the coagulant and flocculant and subsequent separation) may all take place in one tank, and the depiction of separate tanks for storage and treatment is not intended to be limiting.

The grey water treatment tank 300 provides a vessel for removing contaminants from the grey water such that the output from the grey water treatment tank 300 (i.e., treated grey water) can be reused for certain uses (i.e., from the grey water supply tank 310). For example, treated grey water can be used again for shower/tub(s) 230, toilet(s) 225, and laundry 240. Notably, the treated grey water is not routed to sink(s) 235 or other on-board uses that may be used for consumption. In one or more embodiments, the treated grey water is only supplied to the laundry appliance 240, only the shower/tub(s), the toilet(s) 225, or combinations thereof. The grey water treatment tank 300 removes the surfactants (e.g., soap, detergent, soil or other contaminants, which will collectively be referred to as surfactants or interchangeably contaminants hereinafter) from the grey water to form treated grey water via a grey water treatment system. The grey water treatment system may be any suitable treatment to remove surfactants from the grey water. For example, the surfactant removal may be via addition of flocculant and coagulant to the grey water, and subsequent separation.

The surfactant concentration (or, interchangeably, contamination level) may be measured at any suitable point within the grey water reclamation system 200 by any suitable measuring mechanism, including, but not limited to, sensors 350, in order to determine the amount of surfactant within or the contamination level of the grey water. In other embodiments, as will be described below, the turbidity of the treated grey water stream may be measured to determine the treatment parameters. In yet other embodiments, the amount of detergent may be used to determine the treatment parameters. Examples of possible parameters are provided herein, and are not intended to be limiting. For example, in some embodiments, the surfactants may be measured within the grey water treatment tank 300 such as by sensors 350 within the grey water treatment tank 300. The sensors 350 may be used to determine the concentration per volume of detergent and/or surfactant in the grey water, which is subsequently used to calculate the dosage of coagulant and flocculant. In other embodiments, the surfactants may be measured based on usage of the surfactants from the surfactant dispensers on the on-board uses (e.g., the soap and detergent dispensers from the shower/tub(s) and laundry 240). In yet other embodiments, the surfactants may be measured by sensors at the outlet of the on-board uses to determine the inputs into the grey water storage tank 260, or within the grey water storage tank 260, to determine the surfactant concentration in the grey water storage tank 260. For example, in some embodiments, the detergent dispenser in the laundry appliance 240 appliance may measure the amount of detergent dispensed during a load to determine the contamination level of the grey water exiting the laundry appliance 240. Moreover, in some embodiments, each on-board use may include a similar mechanism for determining the contamination level of the grey water leaving the on-board use, such that the contamination level of the grey water storage tank 260 can be calculated. In one or more embodiments, the grey water storage tank 260 may include sensors (e.g., water level sensors) to determine the volume of grey water such that the water quantity can be used in calculating the contamination level as based on the detergent dispenser measurements collected at the individual on-board uses. In certain embodiments, the individual measurements of the grey water contamination level taken at the outlets of the on-board uses may be collectively considered when determining the contamination level of the grey water (e.g., the turbidity of the feeds to the grey water tank 260). In other embodiments, the coagulant and flocculant may be added to the grey water treatment tank 300 (for example, in a predefined dosage or based on the volume of the tank, unrelated to initial contamination level), and the result may be measured post-processing after treatment in the grey water tank 300, for example, by comparing the turbidity in the treated grey water to the desired or predetermined threshold of turbidity (as measured by a nephelometer measuring Nephelometric Turbidity Units (NTUs)), to determine whether the amount of coagulant or flocculant used was sufficient, and require additional dosing of coagulant and/or flocculant accordingly. The predetermined threshold of turbidity may be any suitable amount, and in some embodiments may be under 20 NTUs, or in other embodiments, under 15 NTUs, and in yet further embodiments, under 10 NTUs. As such, based on measurements and collected information regarding the contamination level of the grey water being supplied to the grey water treatment tank 300, the amount of flocculant and coagulant required can be determined as based on the measurements.

In yet another example, the total flow of water from each grey water source can be monitored, such that knowledge of the dose of detergent from the washer (i.e., knowledge of target concentrations of detergent per volume of water), and results from turbidity measurements of various streams (i.e., the treated grey water stream), the system can implement a machine learning algorithm to learn the “typical” concentration of detergent seen in shower water. This concentration can be used as a starting point for dosing where treated grey water stream turbidity is measured and certain detergent concentrations are known, as opposed to sensors directly measuring contamination level. Over time this algorithm can improve and potentially eliminate additional dosing based on the algorithm output for the concentration of surfactant/detergent coming from the shower/tub.

The grey water reclamation system 200 includes flocculant dispenser 302 and coagulant dispenser 304 fluidly connected to the grey water treatment tank 300 to add a predetermined amount of flocculant and a predetermined amount of coagulant to the grey water treatment tank 300, respectively, as based on the detected contamination level of the grey water (e.g., the amount of surfactant within the grey water), the detected amount of surfactant/detergent, or the desired turbidity as compared to the treated grey water turbidity. The treatment is all conducted within the same tank, without requiring transfer of the grey water from tank to tank. As such, the dispensers may supply the flocculant and coagulant to the same tank. In some embodiments, the predetermined amount of flocculant may be based on the amount of coagulant added. The predetermined amount of coagulant may be determined based on measurements of the surfactant usage, surfactant measurements of individual inputs, contamination level of the grey water storage tank 260, turbidity of the treated grey water (as compared with a desired turbidity), and/or combinations thereof. Flocculant and coagulant are used together to remove the contaminants from the grey water to form the treated grey water that can be reused for the certain on-board uses. The coagulant is a chemical for promoting binding of particles within the grey water, and may neutralize or otherwise stabilize the surfactants (i.e., suspended particles) in the grey water. In certain embodiments, the coagulant may include particles with a first side for contacting the soap or detergent particles, and a second side, opposite to the first, for binding with soil particles, to stabilize the contaminants within the grey water. Examples of suitable coagulants include, but are not limited to, aluminum-salt based coagulants. Suitable coagulants stabilize the particles while also binding to soil, and limit rusting caused by oxidation. The predetermined amount of coagulant may, in some embodiments, be based on the concentration of surfactant measured in the grey water treatment tank 300, or, in other embodiments, be based on the amount of detergent/soap used, or may be based, in other embodiments, on the turbidity of the treated grey water (as compared with a desired turbidity), and/or combinations thereof as previously described. In certain embodiments, the predetermined amount of coagulant may be dispensed as a specific weight per volume of grey water in the grey water treatment tank 300, or may be dispensed based on various factors such as, but not limited to, temperature, surfactant concentration, mixing speed, mixing time, and the like.

The flocculant is a chemical used to extract solid particles out of a suspension to sediment (i.e., agglomerate) under the form of floc or flake, for example, to assist in clarifying processes. As such, the flocculant collects the coagulated particles (i.e., the coagulant with the surfactant and soil attached thereto, or pin floc), and forms a floc (or agglomerated floc). Formation of a floc aids in removal of the contaminants from the grey water to form the treated grey water. The flocculant may be any suitable flocculant that maintains the flocs upon mixing and pumping of the grey water, and creates flocs that can be removed via a physical separation process (or, interchangeably, a filtration system). Examples of suitable flocculants include, but are not limited to, anionic flocculants. The predetermined amount of flocculant may be in some embodiments, be based on the type of physical separation technique used, concentration of surfactant measured in the grey water treatment tank 300, or, in other embodiments, be based on the amount of detergent/soap used, as previously described. In certain embodiments, the predetermined amount of flocculant may be dispensed as a specific weight per volume of grey water in the grey water treatment tank 300. In some embodiments, the predetermined amount of flocculant may be based on the predetermined amount of coagulant. As such, in certain embodiments, the measurements of the contamination level of the grey water may use a predetermined amount of coagulant, which may be then used to determine the predetermined amount of flocculant. In other embodiments, the dispenser for the coagulant may measure the amount dispensed, and the predetermined amount of flocculant may be based on the amount of coagulant dispensed, or may be dispensed based on various factors such as, but not limited to, temperature, surfactant concentration, mixing speed, mixing time, and the like.

After the coagulation and flocculation within the grey water treatment tank 300, the flocs are removed via physical separation of filtration. The floc (or agglomerated floc after flocculation) may be any suitable size for separation, for example, in some embodiments, at least 0.25 in in major diameter (based on the largest dimension for the shape of the floc), in other embodiments, at least 0.50 in in major diameter, and in yet further embodiments, at least 1 inch in major diameter. The physical separation or filtration system may be by any suitable process, including but not limited to, a mesh or sieve, a filter cartridge (via a valve), gravity flow filtration (i.e., without a pump), paper/screen filters, open-cell foam filters, or dried out dried out gravity filtration to separate out the flocs from the treated grey water as the treated grey water is exiting the grey water treatment tank 300. In embodiments where the separation is via a filter cartridge, the filter cartridge may include filter media therein to retain the flocs within the cartridge. Thus, the filter cartridge may be replaceable. As such, the treated grey water can be removed from the grey water treatment tank 300 and be routed to the grey water supply tank 310, and the flocs can be drained out of the grey water treatment tank 305.

In one or more embodiments, the grey water reclamation system 200 includes a controller 400 configured to receive data/information from the sensors 350 about the surfactant and/or contamination level of the grey water or turbidity of the treated grey water, and determine the predetermined amount of flocculant and the predetermined amount of coagulant as based on the data/information received at the controller 400. The controller 400 is also configured to provide instructions to the dispensers 302, 304 based on the predetermined amount of flocculant and the predetermined amount of coagulant. Additionally, the controller 400 (or a separate controller (not shown)) is configured to operate the various pumps and valves of the grey water reclamation system 200, although not depicted in FIG. 2, but will be described with reference to FIG. 2. For example, the controller 400 may compare the turbidity as measured by a sensor 350 on the treated grey water tank 310 with a predetermined threshold turbidity to instruct the dispenser(s) 302, 304.

Referring to FIG. 2, a process schematic for a grey water reclamation system 200 is provided. Fresh water is supplied via water fill line 205 to a fresh water storage tank 210, which includes a drain 212. To be used, the water is pumped via the water pump 220 upon activation of one way valve 215 to be routed to the where it is to be used, such as the toilet 225, the shower/tub 230, sink 235, and laundry 240. As described above, the shower/tub 230 and the laundry appliance 240 are on-board uses that generate grey water, which is supplied to the grey water storage tank 260. In some embodiments, hot water is supplied to the shower/tub 230 and the sink 235 via in line heaters 232, 237, respectively. In some instances, the grey water reclamation system 200 further includes a city water inlet source 250 which can provide water to where it is to be used via a one way valve 255 when the recreational vehicle has access to city water systems. The wastewater from the toilet 225 is routed to a black water tank 270 via a flush valve 265. In the grey water reclamation system 200, the wastewater from the sink 235 is also considered black water and is routed to the black water tank 270. The wastewater from the grey water storage tank 260 and the black water tank 270 can be dumped via activating dump valves 275, 280 respectively, when the recreational vehicle is at an emptying location for the wastewater. The grey water storage tank 260 is fluidly connected to the grey water treatment tank 300, where the grey water is treated with coagulant and flocculant and separated as described above. The grey water is supplied from the grey water storage tank 260 to the grey water treatment tank 300 in any suitable manner, such as, but not limited to, by valves and pumps to move the grey water. In certain embodiments, the pumps and valves may be activated by the controller to move a predefined amount of grey water into the grey water treatment tank, as based on the dispensing of the coagulant and/or flocculant.

Treated grey water leaving the grey water treatment tank 300 after separation is supplied to the grey water supply tank 310 to supplement the fresh water in particular on-board uses. The treated grey water may be routed to the grey water supply tank 310 in any suitable manner, such as, but not limited to, by valves and pumps to move the treated grey water. To be used, the treated grey water is pumped via pump 315 and through the diverter valve 320 to the on-board uses of the toilet 225, the shower/tub 230, and the laundry appliance 240. The diverter valve 320 is positioned downstream of the freshwater supply to the sink 235 such that the treated grey water is supplied only to the particular on-board uses that would not be used for consumption (e.g., cooking or drinking). Thus, the treated grey water can supplement the supply from the fresh water tank 210 and the city water inlet 250 to improve the water usage on board the recreational vehicle.

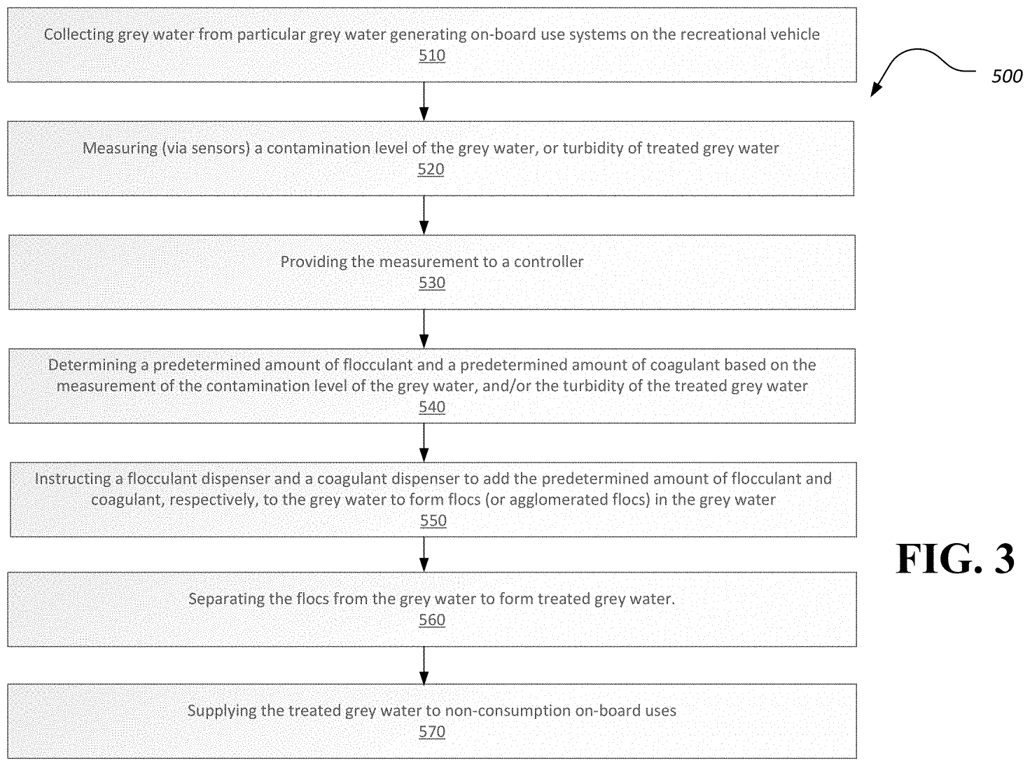

With reference to FIG. 3, a process flow chart for a method 500 of treating grey water in a recreational vehicle is provided. The method includes, at step 510, collecting grey water from particular grey water generating uses on board (i.e., on-board use systems) the recreational vehicle. The grey water generating uses may include the shower/tub and laundry. The method further, at step 520, measuring a contamination level of the grey water, or turbidity of treated grey water, and at step 530, providing the measurement to a controller. At step 540, the controller determines the predetermined amount of flocculant and the predetermined amount of coagulant to be added to the grey water. The predetermined amounts are based on the measurement of the contamination level of the grey water, and/or the turbidity of the treated grey water. The method further includes, at step 550, instructing a flocculant dispenser and a coagulant dispenser to add the predetermined amount of flocculant and the predetermined amount of coagulant, respectively, to the grey water to form flocs (or agglomerated flocs) in the grey water. The method further includes, at step 560, separating the flocs from the grey water to form treated grey water. The method further includes, at step 570, supplying the treated grey water to non-consumption on-board uses. The non-consumption on-board uses include the laundry, the shower/tub, and the toilet. As such, the method 500 provides for reclaiming grey water for particular on-board uses on a recreational vehicle.

According to one or more embodiments, a grey water reclamation system includes various on-board uses that each form one of grey water and black water. The grey water is collected at a grey water storage tank, and is then treated at a grey water treatment tank. The treated grey water can then be reused at particular on-board uses such that overall fresh water usage is reduced, and storage requirements for wastewater can be optimized based on reclaiming a certain volume of water.

Except in any examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. As used herein, the term “about” means that the amount or value in question may be the specific value designated or some other value in its neighborhood. The term “about,” “substantially,” or “generally” denoting a certain value is intended to denote a range within +/−5% of the value. As one example, the phrase “about 100” denotes a range of 100+/−5, i.e. the range from 95 to 105. When the term “about,” “substantially,” or “generally” is used, it can be expected that similar results or effects according to the invention can be obtained within a range of +/−5% of the indicated value. It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Also, unless expressly stated to the contrary: the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended aspects, the singular form “a,” “an,” and “the” comprise plural referents unless the context clearly indicates otherwise. For example, reference to a component in the singular is intended to comprise a plurality of components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A grey water reclamation system for a recreational vehicle comprising:
at least one on-board use system that generates grey water having a contamination level;
a grey water treatment tank fluidly connected to the at least one on-board use systems to collect the grey water and treat the grey water therein to form treated grey water;
a coagulant dispenser fluidly connected to the grey water treatment tank and configured to supply a predetermined amount of coagulant to the grey water in the grey water treatment tank;
a flocculant dispenser fluidly connected to the grey water treatment tank and configured to supply a predetermined amount of flocculant to the grey water in the grey water treatment tank; and
a grey water supply tank fluidly connected to the grey water treatment tank configured to receive the treated grey water therefrom and supply the treated grey water to a particular one of the at least one on-board use systems,
wherein the predetermined amount of coagulant is based on the contamination level or a turbidity of the treated grey water.

2. The grey water reclamation system of claim 1, wherein the predetermined amount of flocculant is based on the predetermined amount of coagulant.

3. The grey water reclamation system of claim 1, wherein the grey water treatment tank includes a filtration system to separate contaminants from the grey water to form the treated grey water.

4. The grey water reclamation system of claim 1, wherein the on-board use is a laundry appliance, a shower, or both.

5. The grey water reclamation system of claim 1, wherein the particular on-board use is a toilet, a laundry appliance, a shower, or combinations thereof.

6. The grey water reclamation system of claim 1, wherein the contamination level is based on an amount of surfactant in the grey water.

7. The grey water reclamation system of claim 6, wherein the amount of surfactant is measured by detecting detergent and soap within the grey water.

8. The grey water reclamation system of claim 6, wherein the surfactant binds to the coagulant.

9. A grey water reclamation system for a recreational vehicle comprising:
an on-board use that generates grey water having a contamination level;
a grey water treatment tank fluidly connected to the on-board uses to collect the grey water and treat the grey water to supply treated grey water to particular on-board uses;
a coagulant dispenser fluidly connected to the grey water treatment tank;
a flocculant dispenser fluidly connected to the grey water treatment tank; and
a controller configured to,
based on the contamination level or a turbidity of the treated grey water, instruct the coagulant dispenser to supply a predetermined amount of coagulant to the grey water treatment tank, and
instruct the flocculant dispenser to supply a predetermined amount of flocculant to the grey water treatment tank.

10. The grey water reclamation system of claim 9, further comprising sensors which detect surfactants and/or contaminants in the grey water, and provide data regarding contamination or turbidity to the controller for determining the contamination level.

11. The grey water reclamation system of claim 9, wherein the on-board use is a laundry appliance, a shower, or both.

12. The grey water reclamation system of claim 9, wherein the particular on-board uses are a toilet, a laundry appliance, a shower, or combinations thereof.

13. The grey water reclamation system of claim 9, wherein the predetermined amount of flocculant is based on the predetermined amount of coagulant.

14. The grey water reclamation system of claim 9, wherein the grey water treatment tank includes a filtration system to separate contaminants from the grey water to form the treated grey water.

15. The grey water reclamation system of claim 9, wherein the treated grey water is supplied to the particular on-board uses downstream of a diverter valve that diverts a fresh water supply to consumable uses on board the recreational vehicle.

16. A method for reclaiming grey water for a recreational vehicle, the method comprising:
determining a contamination level of grey water from an on-board use;
adding a coagulant to the grey water based on the contamination level to form coagulated particles in the grey water;
adding a flocculant to the grey water to aggregate the coagulated particles into flocs;
separating the flocs from the grey water to form treated grey water; and
providing the treated grey water to a laundry device, a toilet, a shower, a tub, or combinations thereof.

17. The method of claim 16, wherein the determining includes measuring surfactants in the grey water.

18. The method of claim 17, wherein the adding the coagulant binds surfactants to the coagulant to form the coagulated particles.

19. The method of claim 16, wherein the on-board use is the laundry device, the shower, or both.

20. The method of claim 16, wherein the separating is via a mesh, sieve, gravity filtration, or a filter cartridge.
